(19) United States
(12) Patent Application Publication
(10) Pub. No.: US 2006/0145530 A1
(43) Pub. Date: Jul. 6, 2006

(54) Flangeless and straight spoked bicycle wheel set

(76) Inventor: Rinard Damon, Monona, WI (US)

Correspondence Address: BARNES & THORNBURG, LLP, P.O. BOX 2786, CHICAGO, IL, 60690-2786, US

(21) Appl. No.: 11/291,044

(22) Filed: Nov. 30, 2005

(30) Foreign Application Priority Data
May 28, 2004 (WO) PCT/US04/16992

(51) Int. Cl. B60B 27/00

(52) U.S. Cl. 301/110.5

(57) ABSTRACT

A high performance bicycle wheel set uses a flangeless front hub with straight spokes perpendicular to a tangent at the biconcave ends of the hub body, with a single flanged rear hub having straight spokes on the nondrive side and “J-bent” spokes in a flange on the drive side.

### CLAIM OF PRIORITY

Priority is claimed based on Provisional Application Ser. No. No. 60/474,796 filed May 30, 2003 and Application PCT US04/16992 filed May 28, 2004, published as WO2004108512 on Dec. 16, 2004.

### BACKGROUND OF THE INVENTION

1. Field of the Invention

The invention is an improved bicycle wheel set having straight spokes and a flangeless hub on the front and a single flange combined with a flangeless biconcave end portion on the rear, providing lighter weight and increased strength and resistance to fatigue in an economical manner and increased (or sufficient) lateral stiffness.

2. Description of Related Art

A number of attempts at designing carbon fiber reinforced plastic bicycle wheel hubs and bicycle wheel hubs with spokes having ends other than the traditional “J” bend have been made. These include commercial products sold by the companies Campagnolo, Velomax and Ultimax. It is believed that the details on construction of these hubs are disclosed in US patents, discussed below.

Campagnolo carbon fiber reinforced plastic hubs use a combination of darts and strips in the fiber layup and have significant shape changes across the hub. The invention here uses more gradual shape changes which enable both superior forming and greater strength due to optimal fiber orientation and fewer discontinuities in the fibers. The Campagnolo carbon fiber reinforced plastic hubs are similar to those shown in U.S. Pat. Nos. 6,688,704 and 6,568,767 and published application 2002-0033635 published Mar. 21, 2002.

Velomax hubs are similar to those shown in Rasmussen, U.S. Pat. No. 5,487,592. These have spokes with the head in the rim, or with nipples in the rim, but with threaded connection in the hubs themselves. The Velomax hub has a pronounced ridge that receives the spokes, the ridge being set in from the actual ends of the hubs. Compared to the Velomax hub, the hubs of the invention avoid the complications of forming the threads in the hub shell, screwing the spokes into the threaded holes, and the forming of large amounts of material to have adequate strength and area for the threaded connection.

The hub sold by Ultimax is believed to be described in Behnke, U.S. Pat. No. 5,494,337 which uses a bell shaped hollow hub with generally straight spokes. The spokes are bent during lacing, tightening and/or truing for the purpose of having the straight spokes resist rotation. The flangeless biconcave hub of the invention discussed in this application avoids the added stress of an elastic bend in the spoke. This reduces the frequency of spokes breaking with use. Thus, they are not truly straight spokes in the finished wheel, and there are stress concentrations as a result of the truing and bending.

Slankard, U.S. Pat. No. 6,018,869 shows a flangeless central hub body, but flanges are added to both sides and there is no teaching of any flangeless spoke connection.

Some, but not all, of other advantages of the present invention are in commercial products. For example, spoke holes favorably angled to point approximately toward the rim are found in Campagnolo and other commercial hubs, but neither to the level of precision shown in this invention or with the optimal orientation to the wall of the hub body. Similarly, the spoke path for assembling the spoke into the hub is a straight line in this invention, but this feature, by itself has been seen on hubs from Campagnolo, Mavic, and others.

In the invention the spoke seat diameter is larger than the bearing outside diameter, to make it possible to remove bearings without removing the spokes. Hubs from Mavic, and Campagnolo have had this feature in the past.

Additionally, straight, threaded spoke ends of “J” bent spokes with the threaded end connected to the hub, and the “J” bend connected to a side wall of the rim are commercially sold by Shimano and are described in numerous patents including, for example, Okajima U.S. Pat. No. 6,382,381 and Nakajima U.S. Pat. No. 6,409,282.

### SUMMARY OF THE INVENTION

A major target of bicycle manufacturers is to reduce the weight of the individual components as much as possible, while keeping manufacturing, assembly and maintenance as simple as possible. In the case of wheel hubs, the first embodiment involves the use of light metal alloys, such as aluminum alloys and similar metallic materials. The flangeless hub design, together with the straight pull spokes, allows the thickness of the hub to change as needed, rather than the flange thickness being determined largely by the length of a J bend spoke's elbow. This gives the designer freedom to optimize the hub thickness to meet the expected stresses: maybe thinner to save weight (when spokes are tensioned less, or when there are more of them, or if the hub shell material does not require so much thickness to meet material performance needs), or thicker to add strength (when spokes are tensioned more, or when there are fewer of them, or when the hub shell material requires thicker walls to meet material performance needs). This ability to optimize opens the door to non-traditional hub shell materials, such as carbon fiber reinforced plastic.

Various solutions have been attempted to further reduce the weight of the wheel hub by using fiber-reinforced plastic materials. In the alternative embodiments, the central tubular part of the wheel hub is made of carbon fiber incorporated in a plastic resin material and in which a pair of side caps made of aluminum alloy are fastened to the ends of the carbon fiber central portion. The side caps are provided with seats for supporting rolling bearings and for anchoring the wheel's spokes. In a second solution the front hub body has a central tubular portion and a pair of side caps, whose diameter is larger than said central portion, so that the hub is a monolith body made of fiber-reinforced plastic material including the central portion and said side caps. Other fibers could be used in addition to or in lieu of carbon.

### BRIEF DESCRIPTION OF THE DRAWINGS

FIG. 1 is a sectional view of a front wheel of the invention with an aluminum hub shell.

FIG. 2 is an enlarged sectional view of the spoke attachment at the hub of the invention.

FIG. 3 is a sectional view of a rear wheel of the invention.

FIG. 4 is enlarged sectional view of the straight spoke attachment at the rear hub of the invention.

FIG. 5 is a perspective view of the front hub of the invention.

FIG. 6 is a right or left side elevational view of the front hub of the invention.

FIG. 7 is a left side elevational view of the rear hub of the invention.

FIG. 8 is a sectional view of a fiber reinforced plastic composite front hub of the invention.

FIG. 9 is a sectional view of a fiber reinforced plastic composite rear hub of the invention.

### DETAILED DESCRIPTION OF THE PREFERRED EMBODIMENT

A front bicycle wheel 10 is typically formed with a rim 12 laced to a hub 14 with left and right sets of spokes 16, 18. A hub 14 has left and right biconcave end portions 20, 22 spaced apart by a typically, generally cylindrical body portion 24. The biconcave body portion or shell 24 has a bore 26 with bearing assemblies 28, 30 at either hub end 32, 34. The bearing assemblies rotatably carry an axle assembly 36. Bearings axles and the related components are advantageously designed to use generally standard, replaceable and serviceable units, known to one of ordinary skill. Bore 26 could be formed through a variety of techniques such as molding, machining or casting, or a combination of these operations.

Each left and right spoke 16, 18 each preferably have heads 40, 42 elongate center portions 44, 46 and threaded end portions 48, 50. End portions 48, 50 are received by left and right spoke nipples 52, 54.

in the instant invention spokes 16, 18 extend along elongate center portions 44, 46 in a straight line to the center of heads 40, 42 from end portions 48, 50. In the prior art (and on one side of the rear hub as described below) spokes were typically terminated in a “J-bend” just before the heads. This enabled the threading of a spoke through a hole in a flange and permitted angular adjustment to a variety of lacing patterns. While having good functionality, stresses were concentrated at the bend and adequate strength required a typically large number of moderately tensioned spokes—typically twenty to about thirty six spokes. More spokes provide greater strength with a weight and aerodynamic penalty. In more modern, high performance bicycle wheels, spoke count is reduced, placing greater demands on the constituent structures. Accordingly, in this invention, straight spokes eliminate the stress concentration at the “J-bend.”

Typical rims 12 have a spoke bed or web, 60 a pair of outwardly extending left and right walls 62, 64 and a tube bed or web 66 with tire bead receiving left and right flanges 68, 70 extending outwardly therefrom. Variations in form include rims for tubular tires which have no flanges and are therefore of a generally box section, albeit with a concave tube bed or web, and more aerodynamic sections in which the walls smoothly and perhaps elliptically taper to a narrower radiused spoke bed, or extremely light weight and strong carbon fiber reinforced plastic rims when low weight is important, e.g., for road race mountain stages. Finally, walls 62, 64 may be formed in intermediate portions 72, 74 and braking surface portions 76, 78. The teachings here are expected adaptable to the various forms described above and familiar to one of ordinary skill in the art.

Axle assembly 36 is composed of axle 80 and left and right end adapters 82, 84 which permit the axle to function when clamped, with a standard quick release mechanism (not shown) into a standard pair of bicycle dropouts. The axle 80 and adapters can be preferably formed of a 7075 or similar aluminum alloy. The body or shell 24 is preferably formed of an aluminum, magnesium, silicon alloy.

Spokes 16, 18 fit a plurality of apertures 86. The lower half of the wheel is shown with the spokes removed. Apertures are bored in the wall 88 of shell 24 near hub ends 32, 34. Preferably about eight to ten apertures are evenly spaced near each end 32, 34. For other wheel designs, such as lower spoke count, adequate material strength and wall thickness can be provided without departing from the invention. Apertures 86 are aligned at an angle from an imaginary vertical line V running through the center plane of the wheel, which angle substantially equals the angle of the spokes 16, 18 from line V. An angle of about 7 to 9 degrees is appropriate for typical hub width and rim diameters. The outer surface of wall 88 is preferably smoothly curved in the biconcave shape described, but a tangent to the outer surface at the center of the aperture 86, as well as the long axis of each spoke 16, 18, presents an angle A of preferably about 90 degrees. In this manner, loads can be maximally borne by the structure, and strength maximized and size and weight minimized.

Spokes 16, 18 will be preferably of the ‘bladed’ type. Bladed spokes provide less aerodynamic resistance than circular section wire spokes. An added benefit of bladed spokes is than in assembly they can be easily held against rotation by a simple tool. As threaded spoke nipples 52, 54 are tightened during wheel assembly and adjustment, any tendency for spoke heads 40, 42 to rotate is thus eliminated by the spoke blade securement tool. Once the spokes are tensioned, and the heads 40, 42 are seated in recesses 90, 92 and resist twisting while under tension and in normal use.

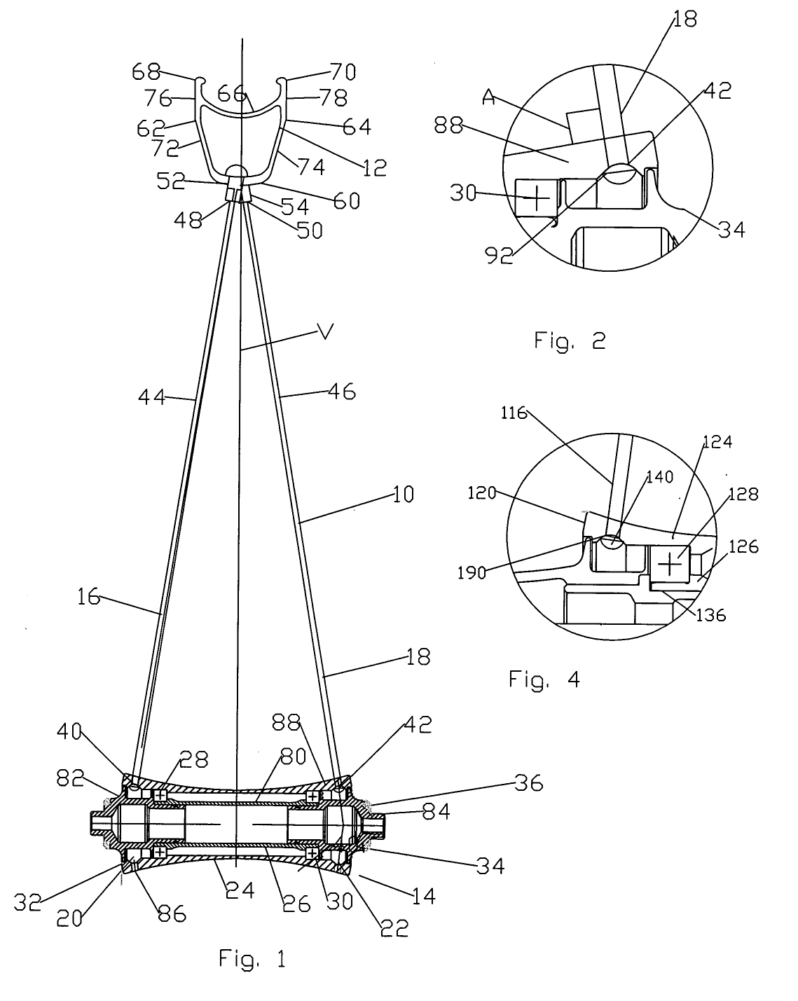

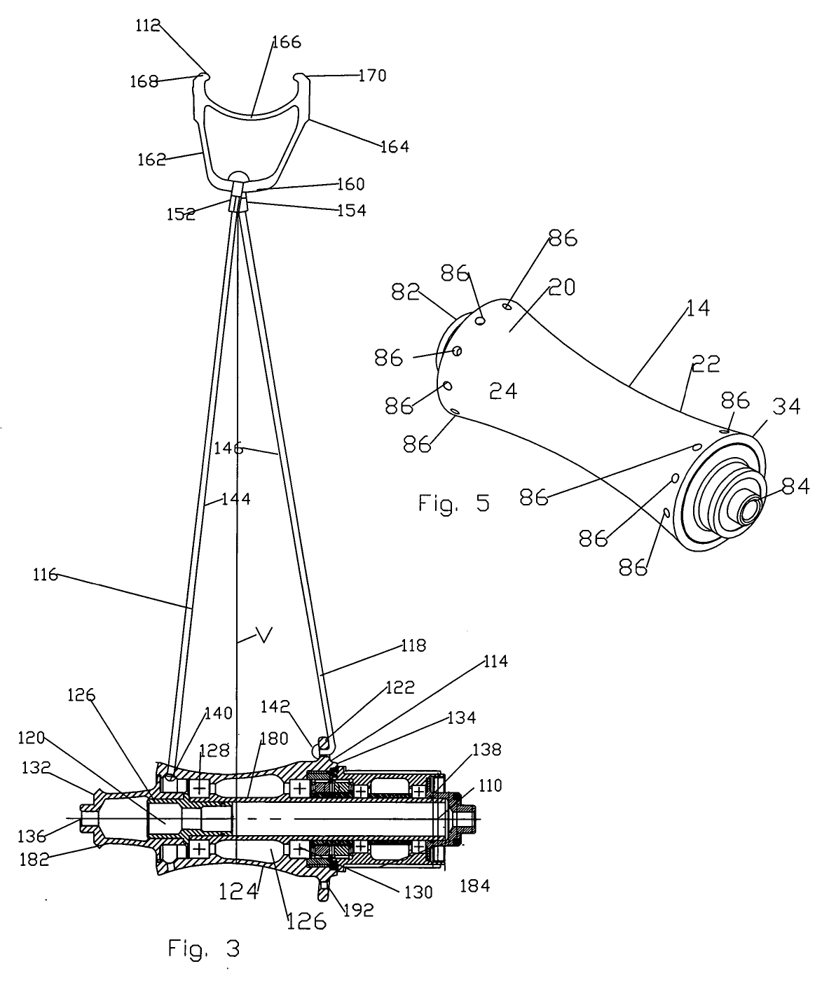

It will also be noted that in the preferred embodiment, of FIG. 1, bore 26 is of substantially constant diameter, as the inside of a cylinder. This is both easy to machine and has the advantage of naturally enabling variable thickness in wall 88 proximate ends 32, 34, acting with the biconcave exterior shape of body or shell 24.

In alternative embodiments, such as forming a hub 200 from the molding of a fiber reinforced plastic, as shown in FIG. 8, thickness of the wall 208 in the central portion 210 of the body 224 may be thinner and of somewhat constant thickness, enlarging near the ends, as needed. For example, bearing seats 230 can be thicker and stronger where needed. Forming bicycle components of complex shapes can be accomplished using the methods taught in principles of optimum compaction low void composite molding in U.S. Pat. Nos. 5,624,519 and 6,270,104, sharing a common assignee with this application. The disclosures in U.S. Pat. Nos. 5,624,519 and 6,270,104 are incorporated by reference as if fully set forth herein.

Other forming methods, such as an external rigid mold with two internal rigid cones (one on each side) can be used to form the conical spoke head seats and an internal bladder (or other flexible pressure applicator, such as a silicone mandrel that expands when heated) that pressurizes the center during cure. After cure and removal from the mold, the spoke holes may be drilled and the bearing seats machined. As described below, in the carbon fiber reinforced plastic version, the conical spoke head seats are not machined, nor is the interior area between the bearings.

Another difference between the embodiments is that the aluminum flangeless hubs such as FIGS. 1 and 2 have a radiused annular groove, more particularly shown in FIG. 2 in the drawings, where spoke head 42 rests. The carbon hub is conical here, as shown in FIG. 8. In fact, the aluminum version could also be conical, but the additional material adds strength needed in aluminum compared to carbon fiber (FIG. 2). While fatigue testing prototype wheels, the conical shape was found to be less sensitive to spoke hole location. This is also a benefit because it demands less precision when drilling the spoke holes—if the hole is drilled a little off the center of the groove, then the spoke head is loaded asymmetrically and soon fails in fatigue.

Prototype testing of carbon fiber hubs with metal reinforcing at the spoke holes, compared to all carbon fiber hub ends, showed that the metal reinforcing cracked due to fatigue after an unacceptably short life. All carbon fiber hub ends lasted over 6 times as long. Of course, thicker metal would add fatigue life, but at the expense of adding weight. In certain situations this weight may be acceptable as a tradeoff, such as for example, where spoke head geometry or finish provides a localized stress on the carbon fiber.

A rear bicycle wheel 110 is typically formed with a rim 112 laced to a hub 114 with straight and J-bend sets of spokes 116, 118. A hub 114 has a left biconcave end portion 120 and a right or drive-side conical flange, 122 spaced apart by a biconcave body portion or shell 124. In the preferred embodiment, the left end portion 120 receives straight spokes 116 as described above with reference to the front hub. In the preferred embodiment, flange 122 receives “J-bend” spokes 118 configured in the familiar manner. Stress is reduced in part, however, because of the conical shape of flange 122, so that the load is borne more directly on the bent portion of the spoke and decreases the spoke's bending on the outside edge of the flange.

The biconcave body portion or shell 124 has a bore 126 with bearing assemblies 128, 130 at either end 132, 134. The bearing assemblies rotatably carry a hollow aluminum alloy axle assembly 136. The bearings and axles are substantially the same on both the aluminum or carbon reinforced plastic hubs, although an additional metal bearing race may be inserted in the carbon reinforced plastic hubs.

On a rear wheel, 110, a drive member 138 carries the cogs through which motive force is transferred from the rider to the wheel 110. As is known to one of ordinary skill, the drive member 138 that predominates on contemporary high performance bicycles has a ratchet internal with the assembly that comprises hub 114. Typically, these fit on splined members. Older, and bicycles of a lower performance design may have a drive member that receives a freewheel that has a ratchet and cogs and typically threaded to the hub 114 at drive member 138. Freewheels typically did not require the extreme wheel “dish” of the contemporary large capacity cogset. Nevertheless, the instant invention is not limited to a particular drive arrangement. Bearings axles and the related components are advantageously designed to use generally standard, replaceable and serviceable units, known to one of ordinary skill.

Left spoke 116 has a straight head 140. Right or drive side spoke 118 has a “J-bend” leading to head 142. Each spoke 116, 118 has an elongate center portions 144, 146 and threaded end portions 148, 150. End portions 148, 150 are received by left and right spoke nipples or nuts 152, 154.

Axle assembly 136 is composed of axle 180 and left and right end adapters 182, 184 which permit the axle to function when clamped, with a quick release mechanism (not shown) into a standard pair of bicycle dropouts. The axle 180 and adapters 182, 184 can be preferably formed of a 7075 or similar aluminum alloy. The body or shell 124 is preferably formed of a fiber reinforced plastic, such as carbon fibers in an epoxy matrix. Adapters 182, 184 can be used in different lengths to customize the fit of the hub 114 to specific bicycle dropout spacing and to specific drive members 138. Compatible axles of slightly different configuration will be familiar to one of ordinary skill.

The lower half of the wheel is shown with the spokes removed. Apertures 186 are bored in the wall 188 of shell 124 proximate end 132. Preferably about ten apertures are evenly spaced near end 132. For other wheel designs, such as lower spoke count wheels, adequate material strength and wall thickness can be provided without departing from the invention. Apertures 186 are aligned as described with the front wheel, at an angle from an imaginary vertical line V running through the center plane of the wheel, which angle substantially equals the angle of the spokes 116 from line V.

An angle of about 5 to 10 degrees is appropriate for typical hub width and rim diameters, but this will vary significantly depending on the structure and specifications of drive member 138. For example, drive mechanism for fewer cogs may require different spoke angles than a drive mechanism for more cogs. Head 140 seats in recess 190.

The drive side spokes 118 transmit rotating rider power to the wheel 110 and this torque places quite different loads and stresses on spokes 118. Flange 122 enables several advantageous features on the drive side of the hub 114. First, different lacing patterns are feasible, in that the apertures 192 permit rotation of the spoke 118 around the axis through head 142 so that different angles relative to the rim (when viewed from the side) can be used. Thus, for a strong rider on a long uphill ride, a different angle of tangency to the flange could be used than for a lighter weight rider on a flat ride, or similar considerations can be used. These different angles of tangency can enable better torsional rigidity between the hub and rim 112. Second, while under torsional load, some slight flexing at the flange may occur as spoke tension increases and decreases under pedaling, and the “J-bend” at head 142 permits this slight movement without concentrating stress as the “J-bend” is received in aperture 192.

One particular rear rim 112 is shown. This has a tube bed or web 166 with tire bead receiving left and right flanges 168, 170 extending outwardly therefrom. The teachings here are expected adaptable to various forms with geometric adjustments such that different rim section shapes can be used—highly aerodynamic shapes for certain conditions, riding styles or preferences such as time trials or triathlons, more box-like shapes for reduced wheel weight or mountain bike use, very light carbon fiber reinforced plastic climbing rims for mountain stages of road races, and the like. This type of rim is analogous to that taught in U.S. Pat. No. 6,679,561 sharing a common assignee with this application. This patent is incorporated by reference as if fully set forth herein.

In the rim illustrated, spoke bed 160 is offset to enable a profile of rim 112 which minimizes the difference in spoke angle between the spokes on the right or drive side 118 and the spokes on the left or nondrive side 116. An advantage to this offset is that it permits a high strength spoke arrangement by raising the tension in the left side spokes compared to a rim whose section is not offset. As can be seen from the drawings, tube bed 166 spans walls 162, 164. In the rim shown, tire bead receiving left and right flanges 168, 170 extend outwardly from said walls 162, 164 at their intersection with said tube bed 166.

More traditional rim orientation could be used, as could more traditional non-paired or staggered spoking arrangements. Similarly, a sectional shape such as shown is readily adaptable to tubular or “sew-up” tires by omitting said flanges, which may yield performance advantages and are preferred by many competitive riders.

Spokes 116, 118 will be preferably of the ‘bladed’ type. Bladed spokes provide less aerodynamic resistance than circular section wire spokes. An added benefit of bladed spokes is than in assembly, the straight spoke 116 can be easily held against rotation by a simple tool. As threaded spoke nipples 152, are tightened during wheel assembly and adjustment, any tendency for spoke heads 140, to rotate is thus eliminated by the spoke blade securement tool. Once the spokes are tensioned, the heads 140, are seated in recess 190 and resist twisting while under tension and in normal use. Spoke 118 has a “J-bend” leading to head 142 and, of course, has no tendency to rotate in the hub while nipple 154 is being tightened. High enough spoke tension is such that the spoke never goes slack in use. Thus, the spoke tension always greater than zero can prevent the spoke from rotating in use. Other anti-rotation methods could also be employed without going outside the scope of the invention, e.g., Lehanneur 1977, GB 1557342.

In the embodiment, of FIG. 1, bore 126 is formed to provide a substantially thin wall in the center, tapering to and then increasing significantly to define thickened portions providing seats for bearings 128, 130. Modern metal forming techniques are perfectly feasible for forming such shapes.

Alternative embodiments, such as forming a hub from the molding of a fiber reinforced plastic, wall thickness in the central portion of the body may be thinner and of somewhat constant thickness, enlarging near the ends, as needed. Thus, as shown in FIG. 8, thickened portions in body 224 can be readily formed to support bearing races 230, while central portion 210 is thinner and lighter.

A separate flange piece can be used for the rear hub. This embodiment is shown in FIG. 9 and will be described in more detail below. These hubs can be manufactured using optimum compaction, low void forming techniques shown in U.S. Pat. Nos. 5,624,519 and 6,270,104, described above, or other forming techniques, such as combining hard mandrels with bladders or inflatable mandrels, as described above.

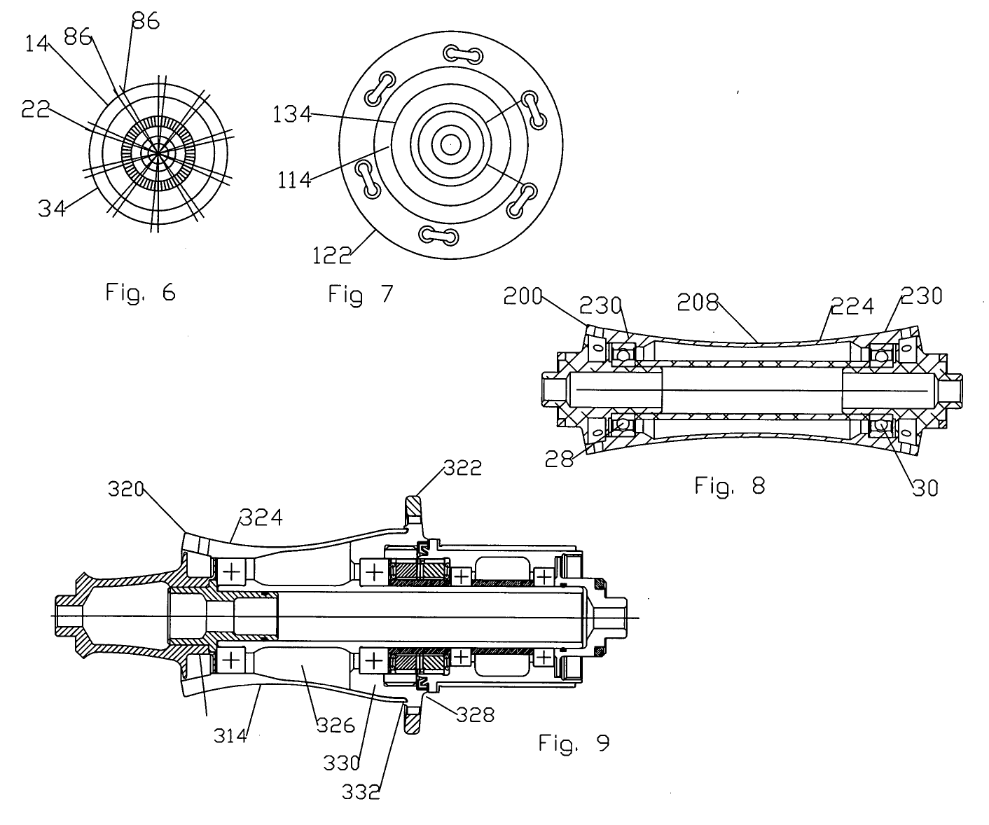

In particular, the U.S. Pat. Nos. 5,624,519 and 6,270,104 teach principles for developing a layup schedule which is adapted to form the hub. FIG. 6B, 13 and 17 of the '519 patent show various arrangements. The “roll” technique might take alternating 0-45-90 unidirectional layers formed into laminations formed and arranged around an internal bladder, placed in a mold and compressed outwardly. The specification of the '519 patent beginning at column 17, line 44 “Formation of the Frame Tubes” describes a metal mandrel, external bladder, autoclave arrangement in which laminations are wrapped around a mandrel. The joining of prepreg lamination “halves” such as the frame lugs could be adapted but is not preferred for use for the hubs. As noted, the preferred embodiment is made using a combination of female mold, inserts and a pressurizing mandrel or bladder.

Important in the formation of the carbon hubs is that the +/− 45 fiber orientation permits smooth changes in diameter of the wrapped layers as the layers are compressed in a mold, thereby permitting conformance to the curvature of the hub walls. Unlike flanged or bell-shaped hubs, the absence of any dramatic directional changes in the surfaces or axes of the walls in the hub of this invention permits the use of continuous fiber prepreg layers without adding darts or tabs. These principles apply to the rear and front hubs, when made from fiber reinforced plastic.

Carbon rear hub 314 is formed extending from end portion 320 to hub flange 322 with shell 324 defining bore 326 through which the axle and bearing assembly is mounted as described above with reference to the one-piece, preferably aluminum, hub.

Due to the unique load requirements of the rear hub and its unique geometry, the two piece bonded hub shown can be used advantageously. Thus shell 324 is one piece, while this rear hub has an aluminum flange piece 328 on the right side. Flange piece 328 includes flange 322 and an inwardly extending boss 330 that mates with body edge 332. Boss 330 is formed to conform to the inner surface that forms bore 326 such that flange piece 328 is bonded to the carbon hub shell 324, such as by epoxy. On the flangeless left side end 320 spoke attachment is through passage through apertures in the same manner as the flangeless side of the aluminum hub, or either side of either embodiment of the front hub.

The preferred right side edge 332 of the carbon rear hub shell 324 may be machined on its inside to precisely fit with the boss 330 of the aluminum right flange piece 328 to facilitate during bonding. Alternatively, a fiber reinforced plastic flange piece could be formed. The structural considerations are somewhat different than those in shell 324, so different fiber orientations could be adapted including 0-45-90 degree laminations and unidirectional ropes or beads, to better withstand the localized loads of the spokes. Because the flange piece 328 need not be hollow, other molding techniques could also be adapted. Metallic reinforcements at the spoke holes is shown in Campagnolo patent.

While the present invention has been disclosed and described with reference to a single embodiment thereof, it will be apparent, as noted above that variations and modifications may be made therein. It is, thus, intended in the following claims to cover each variation and modification that falls within the true spirit and scope of the present invention.

In accordance with my invention, I claim:

1. A wheel hub for rotating about an axle on an axis of rotation, said hub comprising:
a tubular body having two ends, said body having a general shape has continuous gentle curves rather than sharp radii;
said wheel hub is adapted to receive spokes connectable to a rim to form a wheel;
at least one of said ends is provided with a plurality of holes for anchoring the spokes of the wheel;
at least one of said ends is provided with a housing for receiving the external race of a rolling bearing;
at least one of said ends is provided with a housing for receiving a torque-transmitting mechanism;
said hub being formed and arranged so that the spokes may be assembled into the hub without removing the hub axle;
said hub being formed and arranged so that the spokes may be assembled into or removed from the hub without removing the hub bearings and the bearings may be assembled into or removed from the hub without removing the spokes;
said hub being formed and arranged to receive bearings so that said bearings may be assembled into or removed from the hub without removing the spokes;
said hub being formed of a continuous wall having an exterior surface defining said general shape of gentle curves and an interior surface;
said interior surface projecting outwardly in the direction of said bearing seat, said interior surface being formed to be generally conical proximate said end, with the conical apex on the axis of rotation and the conical base proximate the bearing seat such that a spoke seat surface formed on said interior surface is substantially perpendicular to a spoke axis.

2. The hub of claim 1 further comprising:
at least one end of said hub is made of fiber-reinforced plastic material.

3. The hub of claim 1 further comprising:
said hub is symmetric about a plane of rotation such that both ends are formed to be substantially conical.

4. The hub of claim 1 further comprising:
said hub is formed by mating attachment of a flanged drive member to said body;
said flanged drive member having said flange tapered to substantially conform to a spoke line.

5. A wheel hub with a tubular body having a first end and a second end comprising:
said first end is provided with a plurality of holes defined by wall portions completely surrounding said holes, said holes being adapted for anchoring of spokes;
said hub having a biconcave body adapted to receive straight pull spokes in said first end;
said hub body being hollow and formed of a continuous wall;
the thickness of said wall changing from a thin portion near a center and a thick portion at said first end to meet the expected stresses;
said first end being formed and arranged to receive straight spokes;
the thickness of said wall at said first end being chosen based on the number of spokes used in the wheel and the tension applied to said spokes;
said second end formed as one of a mirror image of said first end or a drive flange member receiving portion.

6. The hub of claim 5 further comprising
said hub is formed of a fiber reinforced plastic;
said holes of said first end have a metal reinforcement associated therewith.
said reinforcement being set between the spoke heads and the wall of the hub body.

7. The hub of claim 5 further comprising:
said hub body being formed of fiber reinforced plastic.

8. The hub of claim 5 further comprising:
said hub body being formed of metal.

9. The hub of claim 5 further comprising:
said second end is adapted to receive a flange piece;
said flange piece is bonded to said second end;
said flange piece is formed to receive J-bend spokes on a drive side of a wheel.

10. The hub of claim 9 further comprising:
said flange piece being formed of metal.

11. The hub of claim 9 further comprising:
said flange piece being formed of fiber reinforced plastic.

12. The hub of claim 5 further comprising:
hub is formed of carbon fiber reinforced plastic;
said body includes metallic reinforcements for directly receiving contact of metal components of the wheel.

13. The hub of claim 5 further comprising:
said hub is formed so that spokes meet said first end wall at a normal angle.

14. The hub of claim 13 further comprising:
said hub is formed to have spoke holes angled to point toward a rim;
said first end provides a spoke seat;
the spoke path for assembling the spoke into the hub to form a wheel is a straight line, and
said hub has a spoke seat diameter larger than the outside diameter of an operatively installed bearing to make it possible to remove bearings without removing spokes.

15. A flangeless hub spoked wheel comprising:
said wheel has a hub, said hub having a body adapted to receive straight pull spokes;
said hub body being hollow and formed of a continuous wall;
the thickness of said wall changing from a thin portion near a center and a thick portion at a first end to meet the expected stresses;
said end being formed and arrange to receive spokes;
the thickness of said wall at said end being chosen based on the number of spokes used in the wheel and the tension applied to said spokes;
said hub is formed so that the spokes meet said wall at a normal angle;
said hub is formed to have spoke holes angled to point toward the rim;
said end providing a spoke seat;
the spoke path for assembling the spoke into the hub is a straight line;
said hub has a spoke seat diameter larger than the outside diameter of an operatively installed bearing to make it possible to remove bearings without removing spokes;
spokes are inserted along said path and tensioned to a rim to form a wheel.
